(19) United States
(12) Patent Application Publication
(10) Pub. No.: US 2002/0007902 A1
(43) Pub. Date: Jan. 24, 2002

(54) Method of manufacturing a condiment cup

(76) Inventor: Gary Nance, Modesto, CA (US)

Correspondence Address: ERIC K. KARICH, 905 TURNBERRY DRIVE, MANSFIELD, TX, 76063, US

(21) Appl. No.: 09/969,233

(22) Filed: Oct. 1, 2001

Related U.S. Application Data
(63) Continuation-in-part of application No. 09/590,607, filed on Jun. 9, 2000.
(63) Continuation-in-part of application No. 29/124,653, filed on Jun. 9, 2000, now Pat. No. D445676.
(63) Continuation-in-part of application No. 29/139,331, filed on Mar. 27, 2001.
(63) Continuation-in-part of application No. 29/142,468, filed on May 25, 2001.
(63) Continuation-in-part of application No. 09/896,714, filed on Jun. 30, 2001.
(60) Provisional application No. 60/138,704, filed on Jun. 11, 1999.

(51) Int. Cl. B29C 51/02; B29C 51/14

(52) U.S. Cl. 156/224; 264/512; 264/544; 264/161; 53/477

(57) ABSTRACT

A method of manufacturing a condiment cup teaches the use of a thermoplastic material having a means for resisting oxygen permeation. The thermoplastic material is then thermoformed into the condiment cup having a base and an upwardly extending sidewall that together define a storage space, the upwardly extending sidewall terminating in a perimeter lip that defines an opening for accessing the storage space. The condiment cup further includes a horizontal attachment arm extending outwardly from the perimeter lip. The horizontal attachment arm is then bent downwardly to form an attachment arm extending downwardly from the perimeter flange.

### CROSS-REFERENCE TO RELATED APPLICATIONS

This application for a utility patent is a continuation-in-part of the following previously filed, and still pending, patent applications: application Ser. No. 09/590,607, filed Jun. 9, 2000; application Ser. No. 29/124,653, filed Jun. 9, 2000, now issued as U.S. Pat. No. D 445,676; application Ser. No. 29/139,331, filed Mar. 27, 2001; application Ser. No. 29/142,468, filed May 25, 2001; and application Ser. No. 09/896,714, filed Jun. 30, 2001. This application for a utility patent claims the benefit of U.S. Provisional Application No. 60/138,704, filed Jun. 11, 999.

### STATEMENT REGARDING FEDERALLY SPONSORED RESEARCH

Not Applicable

### BACKGROUND OF THE INVENTION

1. Field of the Invention

This invention relates generally to condiment cups, and more particularly to a method for manufacturing a condiment cup having an attachment arm and an oxygen barrier.

2. Description of Related Art

There is a need in the marketplace for a secondary container that can be readily attached to a storage container. An example of a market for such a product is in the fast food industry. In the sale of fast food, it is desirable to be able to dispense condiments such as ketchup in a condiment cup that can be readily carried with their associated foods, such as french-fries.

It is highly desirable that the condiment cup be securely attachable to the storage container so as to prevent spillage; and it is also desirable that the containers be inexpensive to manufacture, store, ship, and use. To meet this goal, the container must have an attachment arm or arms for attaching the condiment cup to the storage container. It is highly desirable that the condiment cup be constructed so that the attachment arm securely locks onto the storage container.

Garrett, U.S. Pat. No. 2,597,468, teaches a supplementary container for holding cream on the rim of a coffee cup. The supplementary container includes a hook-shaped member for mounting the container on the coffee cup, and a positioning rib that is positioned beneath the hook-shaped member for clamping the coffee cup.

Waterston et al., U.S. Pat. No. 5,097,975, teaches a recyclable materials caddy that can be attached to a waste receptacle. The caddy is constructed of a linear blank of corrugated plastic and includes a metal hangar member that allows the caddy to be mounted on the rim of a wastebasket.

In addition to a need for an attachment arm, the condiment cup must also include an oxygen barrier that prevents oxygen from penetrating the condiment cup once the condiment cup has been sealed and while the condiment cup is in storage. This is important because oxygen tends to penetrate ordinary plastic in sufficient quantities to harm foodstuffs stored therein. For example, ketchup tends to turn brown in the presence of oxygen.

The prior art teaches various supplementary containers that can be mounted upon another container or cup. However, the prior art does not teach a method of manufacturing a condiment container that includes an attachment arm and an oxygen barrier. The present invention fulfills these needs and provides further related advantages as described in the following summary.

### SUMMARY OF THE INVENTION

The present invention teaches certain benefits in construction and use which give rise to the objectives described below.

The present invention provides a method of manufacturing a condiment cup. The method teaches the use of a thermoplastic material having a means for resisting oxygen permeation.

The thermoplastic material is then thermoformed into the condiment cup having a base and an upwardly extending sidewall that together define a storage space, the upwardly extending sidewall terminating in a perimeter lip that defines an opening for accessing the storage space. The condiment cup further includes a horizontal attachment arm extending outwardly from the perimeter flange. The horizontal attachment arm is then bent downwardly to form an attachment arm extending downwardly from the perimeter flange.

A primary objective of the present invention is to provide a method for manufacturing a condiment cup, the method having advantages not taught by the prior art.

Another objective is to provide a method for manufacturing a condiment cup that includes an attachment arm and is resistant to the permeation of oxygen through the condiment cup.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a perspective view of the preferred embodiment of a condiment cup manufactured according to the teachings of the present invention;

FIG. 2 is a front elevational view thereof;

FIG. 3 is a rear side elevational view thereof;

FIG. 4 is a side elevational view thereof;

FIG. 5 is a top plan view thereof;

FIG. 6 is a bottom plan view thereof;

FIG. 7 is a perspective view illustrating how a sealing lid is peeled off of a condiment container;

FIG. 8 is a perspective view illustrating how the condiment container is attached to a storage container with an attachment arm;

FIG. 9 is a is a sectional view thereof taken along line 9-9 in FIG. 8;

FIG. 10 is a front elevational view of an alternative embodiment having a second attachment arm adjacent a grip enhancer opposite the attachment arm;

FIG. 11 is a side elevational view of an alternative embodiment in which the condiment cup is mounted inside the storage container;

FIG. 12 is a side elevational view of an alternative embodiment in which the attachment arm includes a curved spring portion;

FIG. 13 is a top plan view of an alternative embodiment that includes a divider sidewall that separates the condiment container into first and second compartments;

FIG. 14 is a perspective view illustrating a locking button of the attachment arm and a plurality of locking ribs of the grip enhancer;

FIG. 15 is a sectional view thereof taken along line 15-15 in FIG. 14;

FIG. 16 is a perspective view of an alternative embodiment illustrating a condiment cup having a perimeter lip in the shape of a half-circle;

FIG. 17 is a perspective view of an alternative embodiment illustrating a condiment cup having a perimeter lip in the shape of a triangle;

FIG. 18 is a perspective view of an alternative embodiment illustrating a condiment cup having a perimeter lip in the shape of a half-trapezoid;

FIG. 19 is a side elevational view of a composite sheet being formed by a pair of rollers;

FIG. 20 is a perspective view of a mold being used to thermoform the composite sheet;

FIG. 21 is a perspective view of a thermoformed article formed by the mold;

FIG. 22 is a perspective view of a sealing machine being used to seal the sealing lid onto the thermoformed article;

FIG. 23 is an exploded perspective view of a diecutting trim press being used to cut an excess perimeter from the thermoformed article;

FIG. 24 is a side elevational view of a horizontal arm of the condiment cup being shaped by an arm formation die;

FIG. 25 is a top plan view of the condiment cup having the horizontal arm extending outwardly from the perimeter lip;

FIG. 26 is a perspective view of a n alternative embodiment of the mold illustrating the generally conical attachment arm forming region;

FIG. 27 is a top plan view of a second alternative embodiment of the condiment cup;

FIG. 28 is a side elevational view thereof;

FIG. 29 is a perspective view of a third alternative embodiment of the condiment cup;

FIG. 30 is a front elevational view thereof;

FIG. 31 is a rear elevational view thereof;

FIG. 32 is a side elevational view thereof;

FIG. 33 is a top plan view thereof;

FIG. 34 is a bottom plan view thereof;

FIG. 35 is a perspective view of a fourth alternative embodiment of the condiment cup;

FIG. 36 is a front elevational view thereof;

FIG. 37 is a rear elevational view thereof;

FIG. 38 is a side elevational view thereof;

FIG. 39 is a top plan view thereof; and

FIG. 40 is a bottom plan view thereof.

### DETAILED DESCRIPTION OF THE INVENTION

The above described drawing figures illustrate the invention, a condiment cup 10 for containing a condiment 16 and for attachment to a storage container sidewall 14 of a storage container 12. The condiment cup 10 includes a condiment container 20 for storing the condiment 16, an attachment arm 30 for attaching the condiment container 20 to the storage container 12, and a sealing lid 40 for sealing the condiment container 20. The condiment container 20 is typically filled with the condiment 16, such as ketchup, sealed with a sealing lid 40, and then distributed to patrons of fast food restaurants. The patrons then peel off the sealing lid 40 and hang the condiment container 20 on the storage container 12, such as a container of French fries.

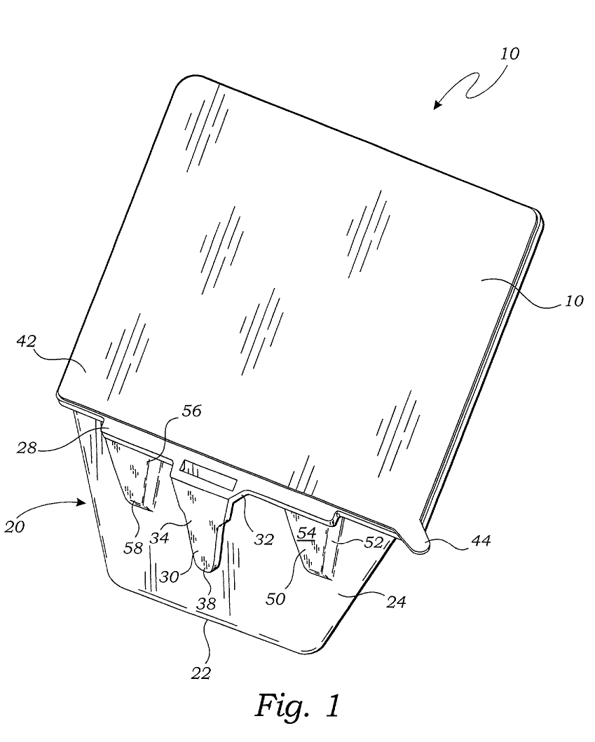

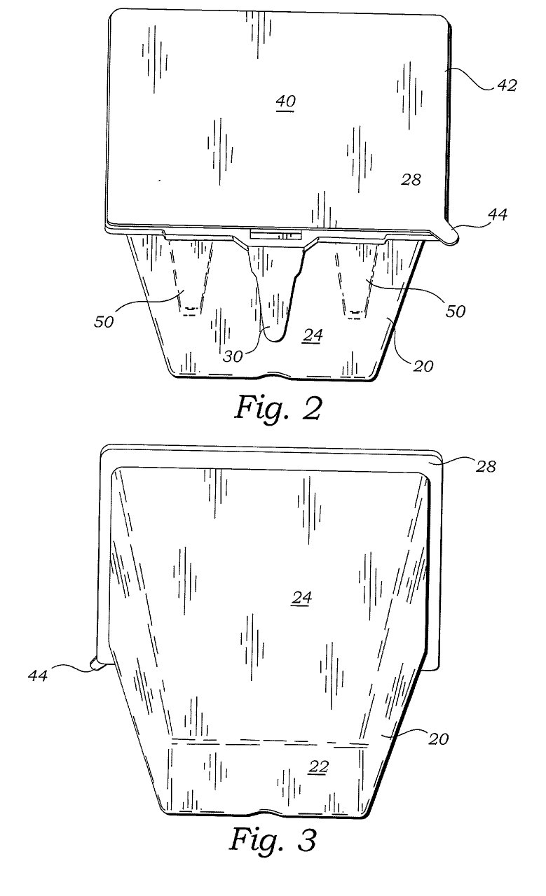

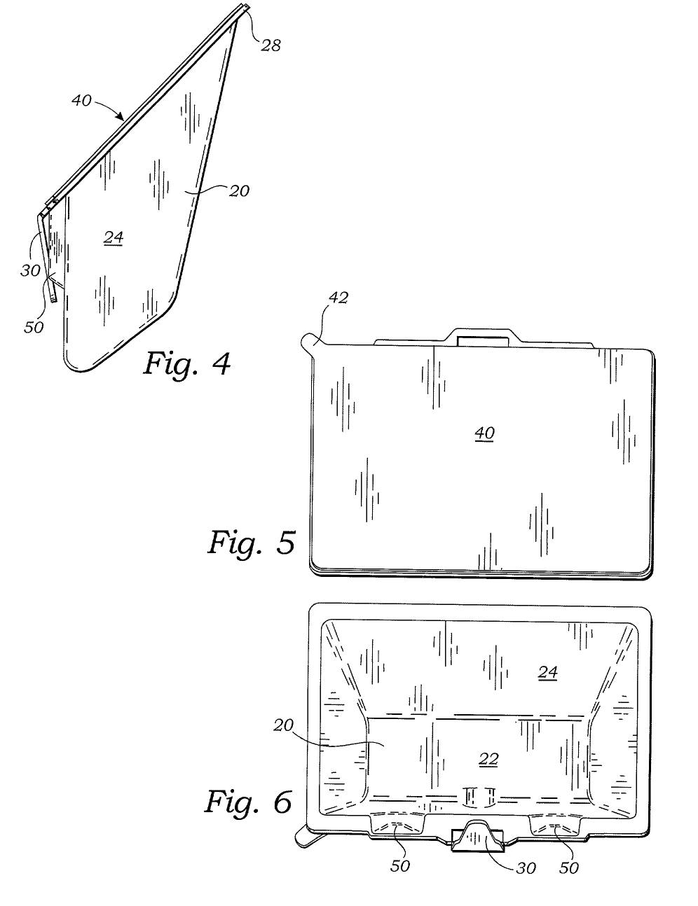

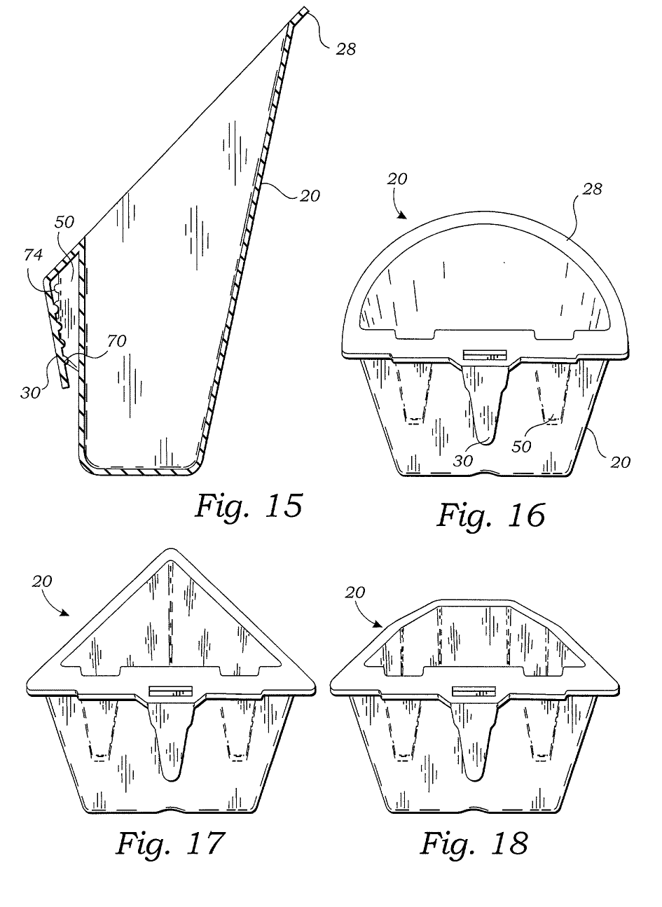

As shown in FIGS. 1-18, the condiment container 20 has a base 22 and an upwardly extending sidewall 24 that together define a storage space 26. The upwardly extending sidewall 24 terminates in a perimeter lip 28 that defines an opening 29 for accessing the storage space 26. The perimeter lip 28 is preferably shaped as an outwardly extending flange for facilitating bonding the sealing lid 40 onto the condiment container 20, as described below. The opening 29 is shaped and sized to enable the patron to easily access the condiment 16 in the condiment container 20, typically by dipping a food product such as French fries into the condiment 16 such as ketchup. The condiment container 20 is preferably constructed of molded plastic, although alternative embodiments might be constructed of paperboard or similar material. The condiment container 20 is preferably generally rectangular in shape; however, as shown in FIGS. 16-18, the condiment container 20 can be constructed of almost any shape, including but not limited to a half-circle, triangular, half-hexagonal, or any other shape, including round or elliptical. The condiment container 20 can also be conical in shape, as the base 22 does not necessarily have to be formed as a flat surface.

As shown in FIGS. 1-18, the condiment cup 10 further includes an attachment arm 30 extending downwardly from the perimeter lip 28. The attachment arm 30 preferably includes an outwardly extending portion 32, a downwardly extending portion 34, and ends at a terminal end 38. The outwardly extending portion 32 and the downwardly extending portion 34 are at least semi-rigid to support the condiment cup 20 as described. The outwardly extending portion 32 functions to outwardly space the downwardly extending portion 34 from the upwardly extending sidewall 24. The attachment arm 30 is preferably integrally molded with the condiment container 20 and extends far enough downward to provide a secure anchor point for the condiment cup 10, but not so far as to interfere with shipping and handling of the condiment cup 10. The attachment arm 30 preferably extends approximately half of the height of the upwardly extending sidewall 24.

Once the condiment container 20 has been filled with the condiment 16, the sealing lid 40 is attached to the condiment container 20. The sealing lid 40 has a lid perimeter 42 that is shaped and adapted to be bonded to the perimeter lip 28 such that the sealing lid 40 seals the opening 29 of the condiment container 20. The sealing lid 40 preferably includes a pull tab 44 that extends outwardly from the lid perimeter 42 for facilitating the peel-removal of the sealing lid 40 from the condiment container 20. The sealing lid 40 is preferably constructed of a thin material such as foil or plastic. The lid perimeter 42 of the sealing lid 40 is preferably bonded to the perimeter lip 28, either with an adhesive or a heat welding, although those skilled in the art may devise other equivalent mechanisms for bonding the two surfaces, and these alternatives should be considered within the scope of the claimed invention.

In use, the patron of a fast food restaurant is given the condiment cup 10 with their meal. For example, when the patron orders French fries, he or she is given a condiment cup 10 that contains ketchup. This of course will vary depending upon the restaurant. A Mexican restaurant might serve nachos, in which case the condiment cup 10 might be filled with salsa or cheese. A chicken restaurant might serve chicken with a condiment cup 10 full of barbeque sauce. Since the condiment cup 10 can hold a large amount of the condiment 16, a single container is all that is required, rather than a large number of small packets of the condiment. The condiment cup 10 reduces waste of the condiment by including the condiment in a single container, rather than dispensing large numbers of small packets.

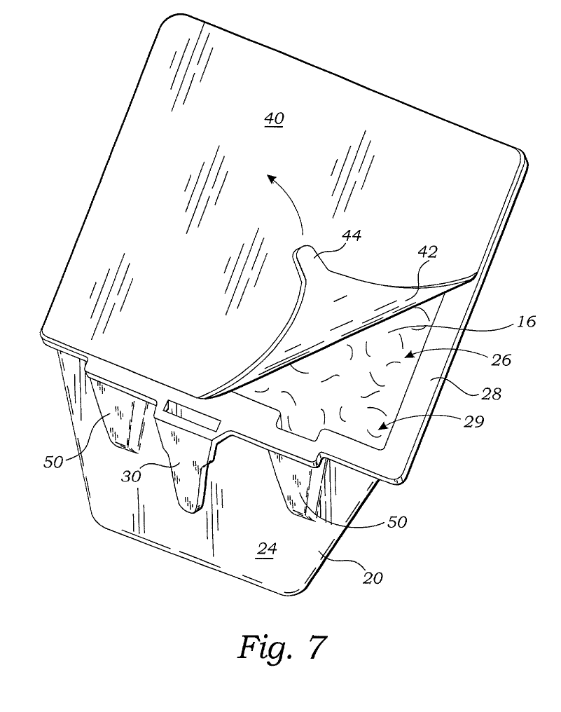

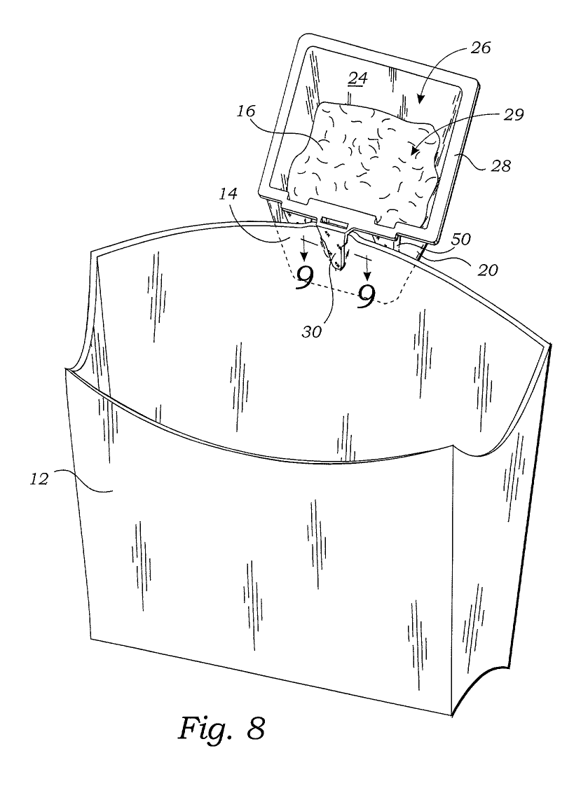

As shown in FIG. 7, when the patron is ready to consume the meal, he or she simply peels the sealing lid 40 from the condiment container 20 to expose the condiment 16. The patron then can hang the condiment container 20 on the storage container sidewall 14 of the storage container 12, as shown in FIG. 8, and dip the food through the opening 29 of the condiment container 20 and into the condiment 16. The condiment cup 10 provides a handy method of dispensing the condiment 16 while the patron eats his or her meal.

As shown in FIGS. 1, 2, 4, 6-10, the condiment cup 10 preferably includes at least one grip enhancer 50 extending outwardly from the upwardly extending sidewall 24 adjacent the attachment arm 30. The at least one grip enhancer 50 provides an outwardly extending sidewall 52 that supports a grip surface 54. The outwardly extending sidewall 52 is preferably integral with the upwardly extending sidewall 24 and extends outwardly from the upwardly extending sidewall 24 approximately the same distance as the outwardly extending portion 32 of the attachment arm 30. For purposes of this application, when we say that the outwardly extending sidewall 52 extends outwardly from the upwardly extending sidewall 24 approximately the same distance as the outwardly extending portion 32 of the attachment arm 30, this is intended to include the situation when the outwardly extending sidewall 52 extends outwardly from the upwardly extending sidewall 24 a distance that is slightly less than the outwardly extending portion 32 of the attachment arm 30—as long as the relationship between the outwardly extending sidewall 52 and the attachment arm 30 is functional to grip the storage container sidewall 14.

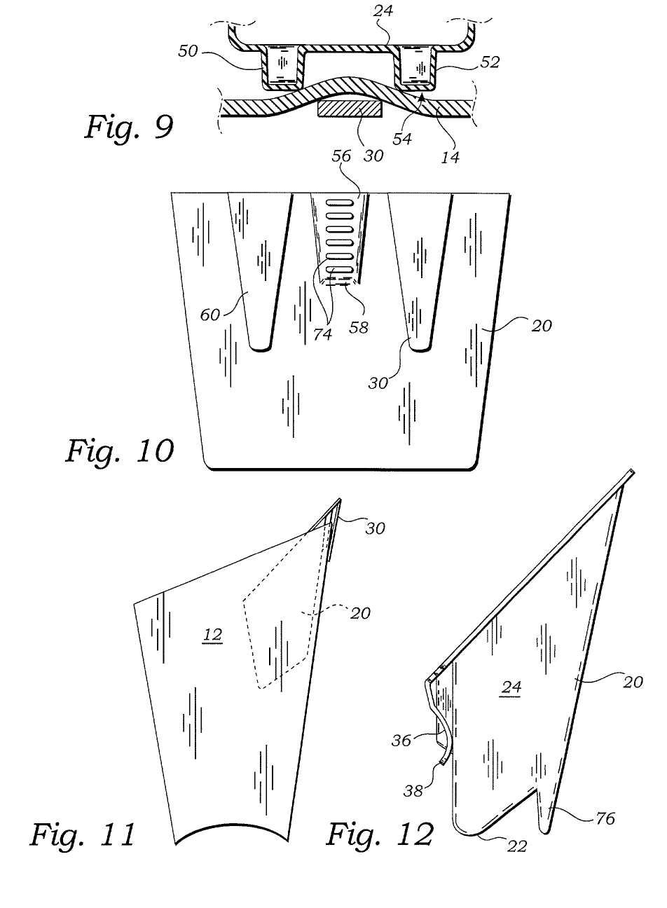

The grip surface 54 is preferably an elongate surface that is generally parallel to the attachment arm 30. The grip surface 54 is vertically aligned with and horizontally spaced from the attachment arm 30. For purposes of this application, vertically aligned means that at least a portion of the grip surface 54 is the same distance from the base 22 as at least a portion of the attachment arm 30; and specifically, that a top edge 56 of the grip surface 54 is higher than a terminal end 38 of the attachment arm 30. In the preferred embodiment, the grip surface 54 is positioned between the outwardly extending portion 32 of the attachment arm 30 and the terminal end 38. As shown in FIG. 9, the grip surface 54 is adapted to cooperate with the attachment arm 30 to clamp the storage container sidewall 14 and thereby support the condiment cup 10 on the storage container sidewall 14.

In a first embodiment, as shown in FIG. 1, the at least one grip enhancer 50 includes two grip enhancers 50, each of the two grip enhancers 50 being horizontally spaced on either side of the attachment arm 30. The grip surface 54 of the grip enhancers 50 are adapted to cooperate with the attachment arm 30 to clamp the storage container sidewall 14 and thereby support the condiment cup 10 on the storage container sidewall 14.

In a second embodiment, as shown in FIG. 10, the condiment cup 10 includes a second attachment arm 60 and a single grip enhancer 50. The grip enhancer 50 is positioned between the attachment arm 30 and the second attachment arm 60. The grip surface 54 of the grip enhancer 50 is adapted to cooperate with the attachment arm 30 and the second attachment arm 60 to clamp the storage container sidewall 14 and thereby support the condiment cup 10 on the storage container sidewall 14.

In an alternative embodiment, as shown in FIG. 12, the attachment arm 30 includes a curved spring portion 36 extending to the terminal end 38 that is outturned away from the upwardly extending sidewall 24. The attachment arm 30 is preferably constructed of a resilient material that enables the curved spring portion 36 to bend and accommodate the storage container sidewall 14 when the terminal end 38 captures the storage container sidewall 14, the curved spring portion 36 then functioning to bias the attachment arm 30 against the storage container sidewall 14, thereby further enhancing the grip of the attachment arm 30 against the storage container sidewall 14.

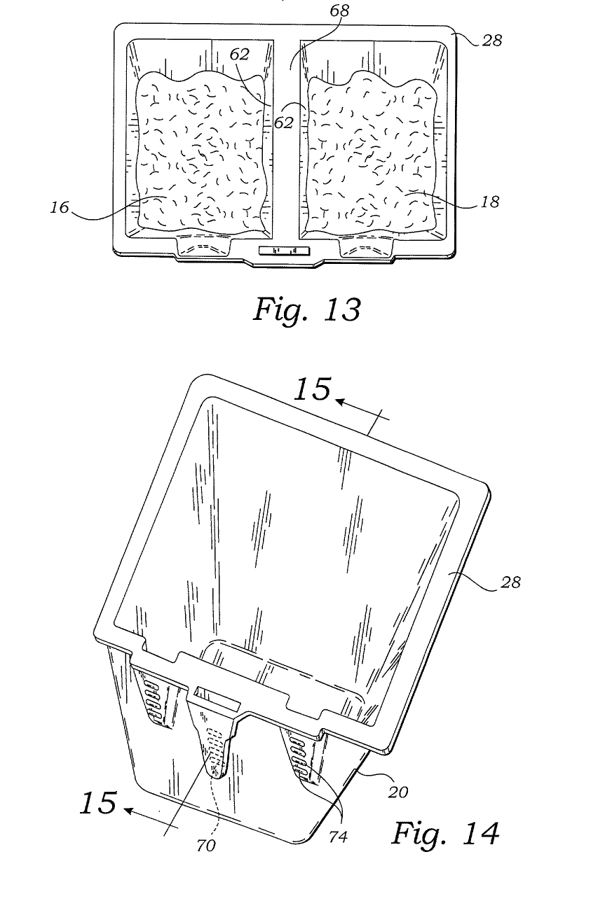

In an alternative embodiment, as shown in FIG. 13, the condiment cup 10 further includes a divider sidewall 62 that is integral with the base 22 and the upwardly extending sidewall 24 and positioned to separate the storage space 26 into a first compartment 64 and a second compartment 66. The divider sidewall 62 includes a divider lip 68 that is adapted to be bonded to the sealing lid 40, thereby sealing the divider sidewall 62 and separating the first compartment 64 from the second compartment 66. This enables the storage of both the condiment 16 and a second condiment 18 within the condiment cup 10. For example, the condiment cup 10 could be used to store ketchup and barbeque sauce, cheese and salsa, chocolate and sprinkles, or any number of combinations of condiments.

In an alternative embodiment, as shown in FIGS. 14 and 15, the condiment cup 10 further includes a locking button 70 or buttons extending from an inner surface of the attachment arm 30. The locking button 70 functions to increase the strength of the connection between the condiment cup 10 and the storage container sidewall 14. The connection can be especially strong if the storage container sidewall 14 includes a dimple that matches the locking button 70.

In an alternative embodiment, as shown in FIGS. 10, 14, and 15, the condiment cup 10 further includes a plurality of locking ribs 74 extending from the grip surface 54 of the at least one grip enhancer 50. The plurality of locking ribs 74 further function to increase the strength of the grip of the at least one grip enhancer 50 upon the storage container sidewall 14.

The condiment container 20 preferably has a base 22 that is angled, as shown in FIGS. 3 and 15, to facilitate dipping the food into the condiment 16. In one embodiment, as shown in FIG. 12, the condiment cup 10 further includes at least one support leg 76 extending downwardly from the base 22 of the condiment container 20. The at least one support leg 76 is adapted to cooperate with the base 22 to support the condiment container 20 in an upright orientation when the condiment container 20 is placed upon a surface.

In an alternative embodiment, as shown in FIG. 15, the base 22 is planar and adapted to support the condiment cup 10 on a surface such as a table, in addition to attaching the condiment cup 10 onto the storage container sidewall 14.

The invention further includes a method of manufacturing the condiment cup 10 described above. The condiment cup 10 is preferably constructed of a thermoplastic material 91 having a means for resisting oxygen permeation. The thermoplastic material 91 is thermoformed using a mold 80 into the condiment cup 10 described above.

According to the preferred method, the mold 80, described in greater detail below, is adapted for thermoforming a composite sheet 90 of the thermoplastic material 91 into the condiment cup 10. The composite sheet 90 includes a thermoplastic material 91 and a means for resisting oxygen permeation. The thermoplastic material 91 preferably includes polyethylene and/or polypropylene, although those skilled in the art of polymers and plastics can devise alternative materials that will function in the present invention. The thermoplastic material 91 is then integrated with the means for resisting oxygen permeation, described below.

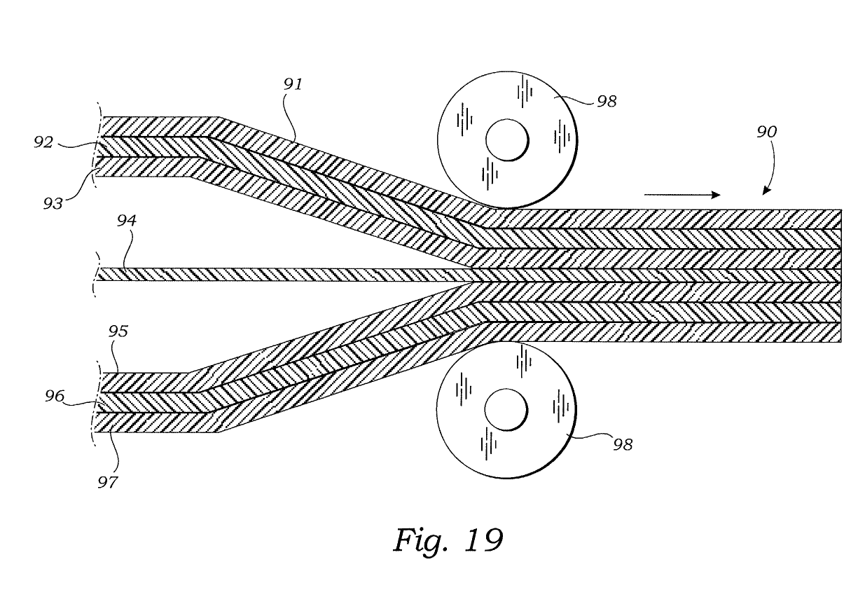

In the preferred embodiment, as shown in FIG. 19, the means for resisting oxygen permeation is a sheet of ethyl vinyl alcohol (EVOH) 94, although other materials can also be used, including but not limited to a copolymer of vinyl chloride and vinylidene chloride sold under the name SARAN® by the DOW® Chemical Corporation. In this embodiment, the thermoplastic material 91 is integrated with the sheet of EVOH 94 by sandwiching the sheet of EVOH 94 between first and second sheets of thermoplastic material 91 and 97 to form the composite sheet 90. In this embodiment, the composite sheet 90 includes, in a stack, a first sheet of thermoplastic material 91, a first sheet of plastic adhesive 92, a first sheet of EVOH adhesive 93, the sheet of EVOH 94, a second sheet of EVOH adhesive 95, a second sheet of plastic adhesive 96, and then the second sheet of thermoplastic material 97. The stack is compressed using a pair of rollers 98 to form a composite sheet 90.

In this embodiment, the first and second sheets of thermoplastic material 91 and 97 are preferably polyethylene or polypropylene, and these layers provide the basic structural support for the condiment cup 10, as well as a safe surface for contacting the condiment 16 or other food product. The first and second sheets of plastic adhesive 92 and 96 are adhesives that bond to the first and second sheets of thermoplastic materials 91 and 97, respectively. Since the sheet of EVOH 94 will not typically bond with the first and second sheets of plastic adhesives 92 and 96, the sheet of EVOH 94 is sandwiched between the first and second sheets of EVOH adhesive 93 and 95 which are designed to bond to the sheet of EVOH 94, and then function to bond to the first and second sheets of plastic adhesive 92 and 96. The adhesives described herein are well known in the art, and are therefore not described in greater detail herein.

In another embodiment, the means for resisting oxygen permeation is an oxygen resistant additive that is added to the thermoplastic material 91. The oxygen resistant additive and the thermoplastic material 91 are melted, mixed together, and then poured into a sheet or other shape and cooled to form the composite sheet 90. In the preferred embodiment, the oxygen resistant additive is the formulation sold by the DOW® Chemical Company under the name NMDX6®. This composite sheet 90 can be used in the thermoforming process described herein, or alternatively used in an injection molding process to form the condiment cup 10.

While the above description of the thermoplastic material 91 describes the preferred embodiment in which the thermoplastic material 91 is in the form of a sheet, it is specifically contemplated that the scope of the invention should not be limited thereto. While providing the thermoplastic material 91 in the form of a sheet is particularly suitable for the thermoforming process, the thermoplastic material 91 could be shaped in any manner of “blank” that can be utilized in the thermoforming process. Those skilled in this art can devise alternative shapes that can be used, and these alternatives are considered within the scope of the claimed invention.

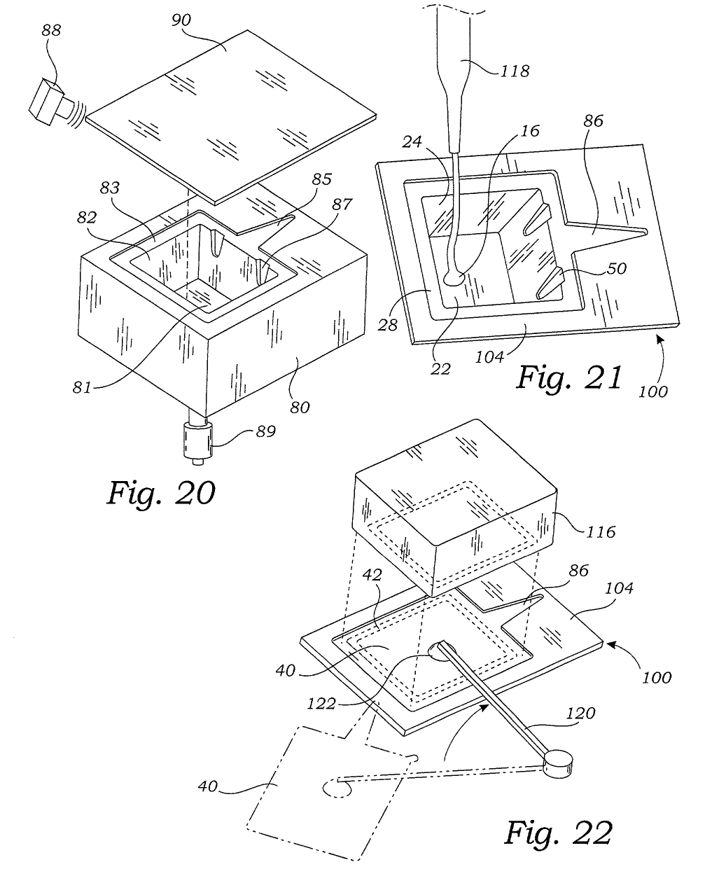

Once the thermoplastic material 91 has been integrated with the means for resisting oxygen permeation to form the composite sheet 90, the composite sheet 90 is ready to be thermoformed into the condiment cup 10. As shown in FIG. 20, the composite sheet 90 is heated above the heat distortion temperature of the composite sheet 90 with a thermoform heater 88 and thermoformed onto the mold 80 such that the composite sheet 90 is shaped by the mold 80 into a thermoformed article 100. A vacuum 89 operably attached to the mold 80 can be used to force the composite sheet 90 onto the mold 80; however, alternative mechanisms well known in the art, such as air pressure or other means, can also be used to similar and equivalent effect.

The mold 80 has a base forming region 81, an upwardly extending sidewall forming region 82, and a perimeter lip forming region 83, each of the regions of the mold 80 being adapted for forming a respective portion of the condiment cup 10. The perimeter lip forming region 83 includes an attachment arm forming region, described in greater detail below. The attachment arm forming region is shaped to form the attachment arm 30 portion of the condiment cup 10, at least partially while the thermoformed article 100 is impressed onto the mold 80. The attachment arm forming region can vary, however, depending upon the particular process selected, and the various equivalent processes available should be considered within the scope of the claimed invention.

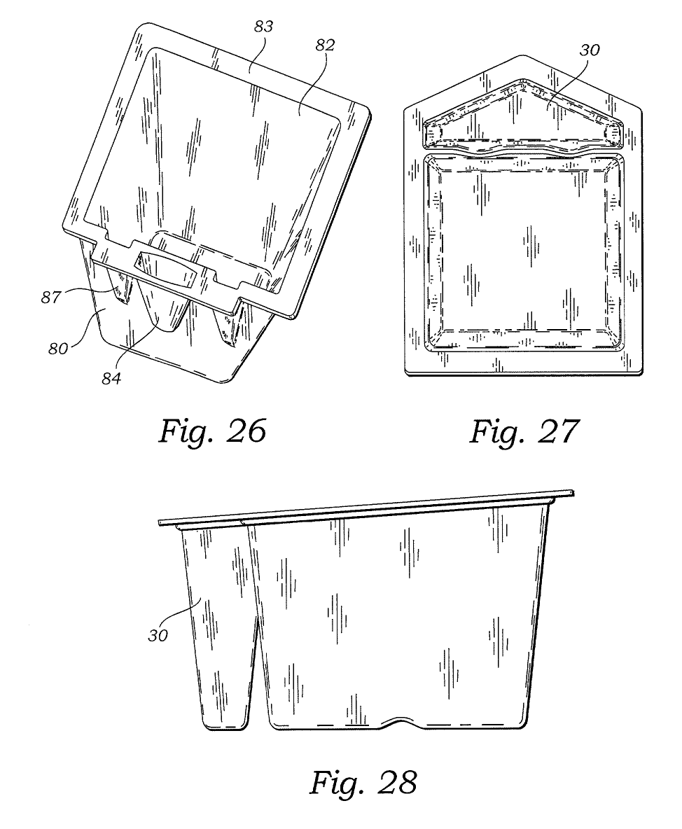

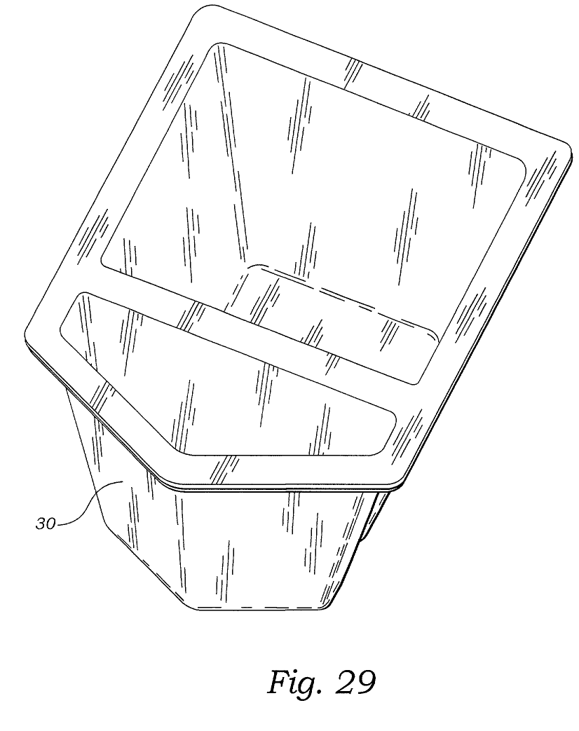

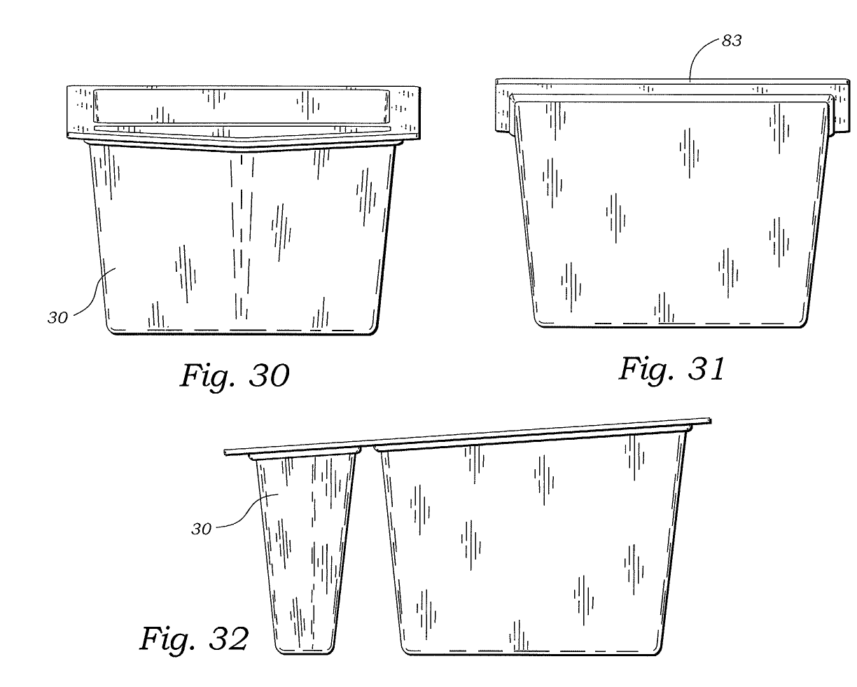

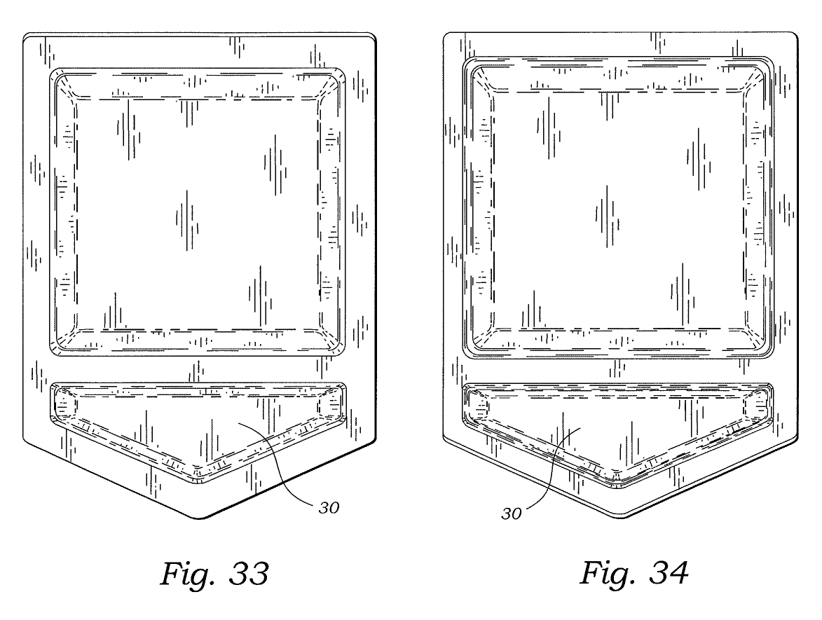

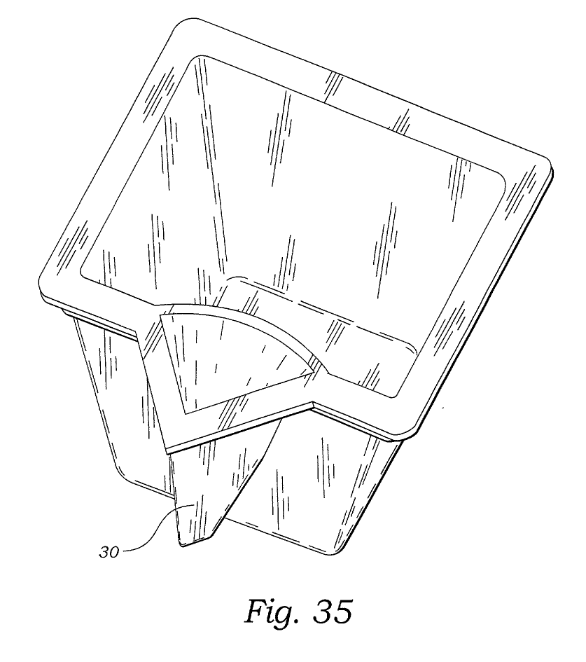

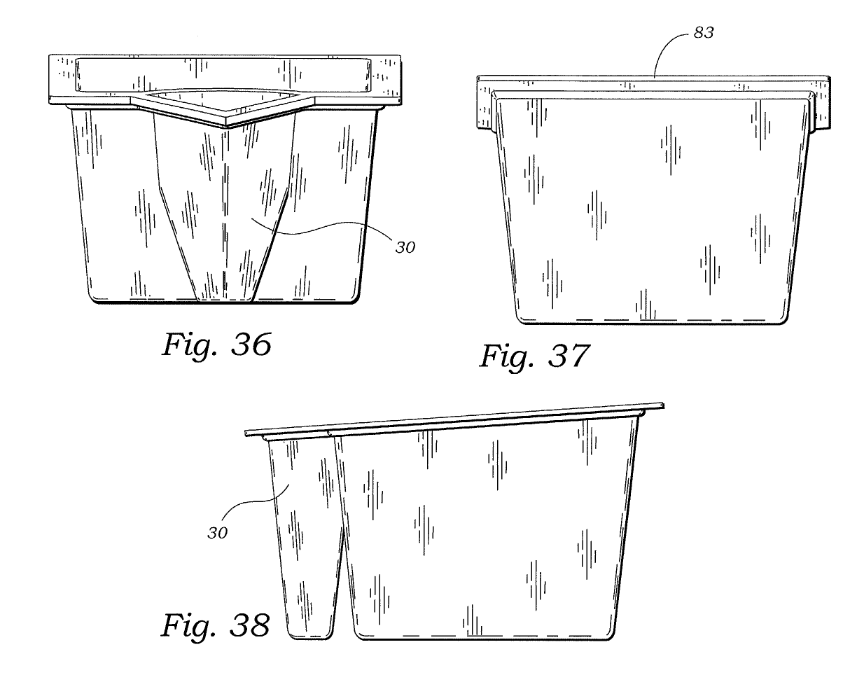

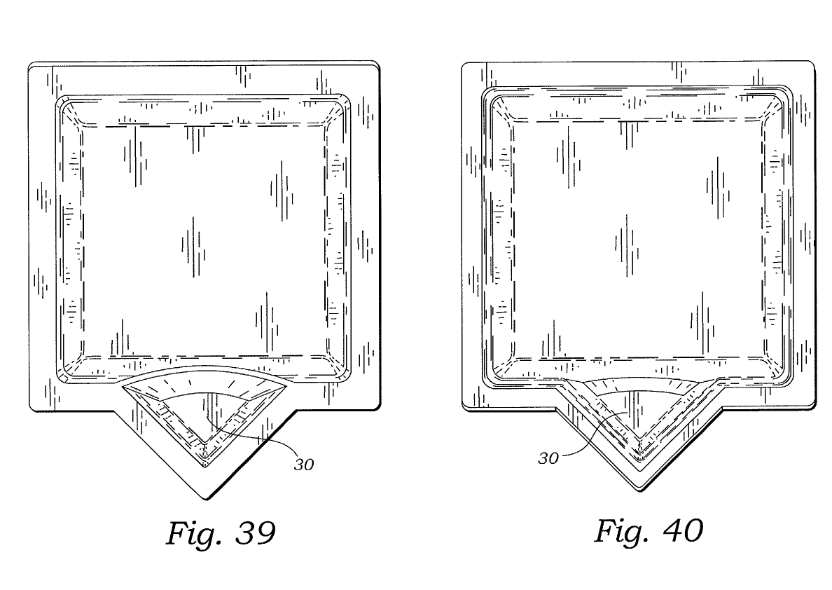

In a first embodiment, as shown in FIG. 26, the attachment arm forming region includes a is generally conical attachment arm forming region 84 that is shaped to form an attachment arm 30 that is generally conical in shape and extends downwardly from the perimeter lip 28. In this embodiment, the step of forming the attachment arm 30 is completed entirely during the initial thermoforming step. The generally conical shape of the attachment arm 30 formed enables the attachment arm 30 to be produced using just the thermoforming process without additional shaping or molding. The generally conical shape functions to provide the strength required to support the condiment cup 10 upon the storage container 12. The shape that we use to describe the attachment arm 30 of this embodiment, which we call generally conical, is meant to include similar shapes beyond the scope of the literal meaning of conical. Similar shapes include any manner of generally tapered hollow shapes, whether their cross section is circular, square, oval, or any other shape. Furthermore, the shape does not have to terminate at a point, but can terminate in any shape, whether a point, line, geometric shape, or similar blunt end. Various alternative embodiments of the condiment cup 10 utilizing this design are illustrated in FIGS. 27-40.

In a second embodiment, as shown in FIGS. 20-25, the attachment arm forming region of the mold 80 preferably includes a horizontal arm forming region 85 that extends outwardly from the perimeter lip forming region 83 such that, when the composite sheet 90 is thermoformed, a horizontal arm 86 is formed. The horizontal arm 86 is an outwardly extending flange having dimensions generally equal to the dimensions of the attachment arm 30 that is desired. The horizontal arm 30 is preferably further defined during the trimming step, resulting in a condiment cup 10 having a horizontal arm 86, as shown in FIG. 25.

As shown in FIG. 24, once the horizontal arm 86 has been formed, it is heated and shaped into the attachment arm 30 using an arm formation die 110. The arm formation die 110, or an equivalent mechanism, first heats a portion 114 of the horizontal arm 86 with an arm heater 112 at a point near the perimeter lip 28 so that the portion 114 is temporarily soft and malleable. At this moment, the arm formation die 110 stamps the horizontal arm 86 into the shape of the attachment arm 30. Once the attachment arm 30 cools, the plastic rigidly sets in the new shape.

As shown in FIG. 20, the mold 80 preferably further comprises at least one grip enhancer forming region 87 that functions to form, on the condiment cup 10, the at least one grip enhancer 50 extending outwardly from the upwardly extending sidewall 24 adjacent the attachment arm 30, as described above. The mold 80 can include two or more grip enhancer regions 87, each of the grip enhancer regions 87 functioning to form, on the condiment cup 10, a grip enhancer 50, each of the two grip enhancers 50 being horizontally spaced on either side of the attachment arm 30.

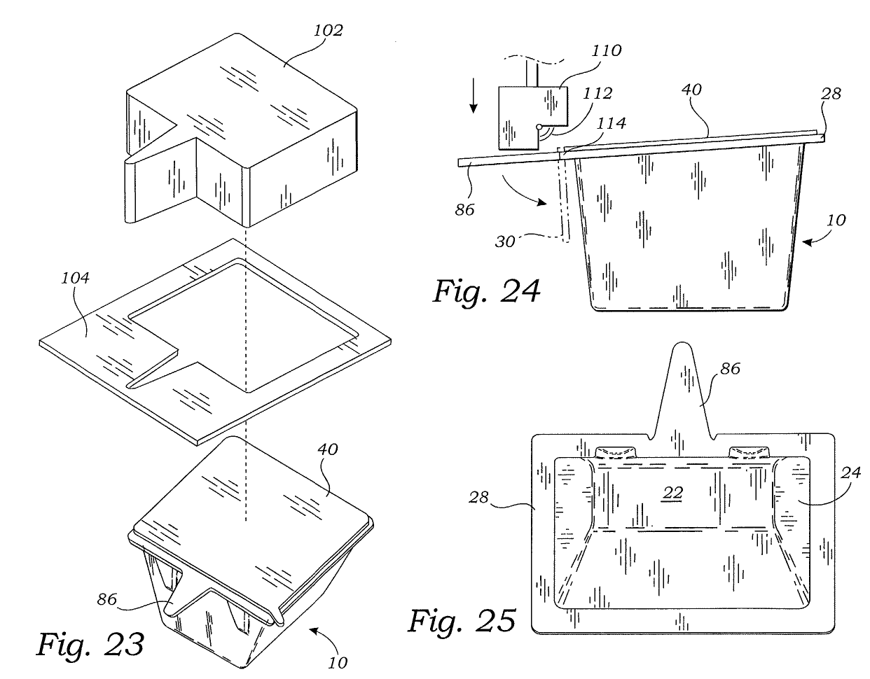

As shown in FIGS. 21-23, when the thermoformed article 100 is removed from the mold 80, the thermoformed article 100 includes both the condiment cup 10 and an excess perimeter 104 extending outwardly from the perimeter lip 28. At a later stage, as shown in FIG. 23, the thermoformed article 100 is trimmed in a diecutting trim press 102 to separate the condiment cup 10 from the excess perimeter 104. The construction of the diecutting trim press 102 is well known to those skilled in the art, and is therefore not described in greater detail herein.

At some point in the production, the condiment cup 10 is filled with the condiment 16 and sealed with the sealing lid 40. First, as shown in FIG. 21, the condiment 16 or similar food product is deposited into the storage space 26 of the condiment cup 10. If the condiment cup 10 includes the second compartment 66, the second condiment 18 is added, either simultaneously or as an additional filling step.

As shown in FIG. 22, the sealing lid 40 is positioned on top of the perimeter lip 28 such that the lid perimeter 42 abuts the perimeter lip 28. This step is typically performed automatically using a pivot arm 120 that is controlled by an automated machine. The pivot arm 120 typically includes a suction cup 122 that functions to grab the sealing lid 40 and then release the sealing lid 40 at the proper time. The construction and control of such a pivot arm 120 is known in the art, and therefore not described in greater detail herein. Finally, the lid perimeter 42 is sealed to the perimeter lip 28 using a sealing machine 116, thereby sealing closed the opening 29 of the condiment cup 10. The sealing machine 116 typically uses a burst of sonic energy to weld the sealing lid 40 to the perimeter lip 28. The construction of to the sealing machine 116 utilized in the present method is well known in the art, and is therefore not described in greater detail herein.

The steps of filling and sealing are preferably performed to the thermoformed article 100 prior to the trimming using the diecutting trim press 102, although the order of these steps can be modified by those skilled in the art depending upon the production strategy of the manufacturer.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A method of manufacturing a condiment cup, the method comprising the steps of:
providing a mold adapted for thermoforming the condiment cup, the mold having a base forming region, an upwardly extending sidewall forming region, and a perimeter lip forming region, the perimeter lip forming region having an attachment arm forming region;
providing a composite sheet that includes a thermoplastic material and a means for resisting oxygen permeation;
heating the composite sheet above the heat distortion temperature of the composite sheet;
thermoforming the composite sheet onto the mold such that the composite sheet is shaped by the mold into a thermoformed article, the thermoformed article including both the condiment cup and an excess perimeter, the condiment cup having a base and an upwardly extending sidewall that together define a storage space, the upwardly extending sidewall terminating in a perimeter lip that defines an opening for accessing the storage space;
trimming the thermoformed article in a diecutting trim press to separate the condiment cup from the excess perimeter; and
forming, at least partially while the thermoformed article is impressed onto the mold, an attachment arm extending downwardly from the perimeter lip.

2. The method of claim 1 wherein the attachment arm forming region of the mold is generally conical in shape and extends downwardly from the perimeter lip forming region, and wherein the step of forming the attachment arm is completed entirely during the thermoforming step.

3. The method of claim 1 wherein the attachment arm forming region of the mold extends outwardly from the perimeter lip forming region such that, when the composite sheet is thermoformed, a horizontal arm is formed, the horizontal arm being further defined during the trimming step, and then further including the steps of heating and shaping the horizontal arm into the attachment arm using an arm formation die.

4. The method of claim 1 wherein the means for resisting oxygen permeation is a sheet of EVOH, and wherein the method of integrating the thermoplastic material with the sheet of EVOH to form the composite sheet comprises the steps of:
providing, in a stack, a first sheet of thermoplastic material, a first sheet of plastic adhesive, a first sheet of EVOH adhesive, the sheet of EVOH, a second sheet of EVOH adhesive, a second sheet of plastic adhesive, and then a second sheet of thermoplastic material; and
compressing the stack using a pair of rollers to form the composite sheet.

5. The method of claim 4 wherein the first and second sheets of thermoplastic material include either polyethylene o r polypropylene.

6. The method of claim 1 wherein the means for resisting oxygen permeation is an oxygen resistant additive that is added to the thermoplastic material, and together the oxygen resistant additive and the thermoplastic material are melted, mixed, and then poured into a sheet and cooled to form the composite sheet.

7. The method of claim 1 further comprising the steps of:
depositing a condiment into the storage space of the condiment cup;
providing a sealing lid having a lid perimeter;
positioning the sealing lid on top of the perimeter lip such that the lid perimeter abuts the perimeter lip; and
sealing the lid perimeter to the perimeter lip, thereby sealing closed the opening of the condiment cup.

8. The method of claim 1 wherein the mold further comprises at least one grip enhancer forming region that functions to form, on the condiment cup, at least one grip enhancer extending outwardly from the upwardly extending sidewall adjacent the attachment arm, the at least one grip enhancer providing an outwardly extending sidewall that is integral with the upwardly extending sidewall and supports a grip surface, the grip surface being an elongate surface that is vertically aligned with and horizontally spaced from the attachment arm, a top edge of the grip surface being located further from the base than the terminal end of the attachment arm such that the grip surface is adapted to cooperate with the attachment arm to clamp the storage container sidewall and thereby support the condiment cup on the storage container sidewall.

9. The method of claim 2 wherein the mold includes two grip enhancer regions, each of the grip enhancer regions functioning to form, on the condiment cup, a grip enhancer, each of the two grip enhancers being horizontally spaced on either side of the attachment arm.

10. A method of manufacturing a condiment cup, the method comprising the steps of:
providing a thermoplastic material having a means for resisting oxygen permeation;
thermoforming the thermoplastic material into the condiment cup, the condiment cup having a base and an upwardly extending sidewall that together define a storage space, the upwardly extending sidewall terminating in a perimeter lip that defines an opening for accessing the storage space, the condiment cup further including a horizontal attachment arm extending outwardly from the perimeter lip; and
bending the horizontal attachment arm downwardly to form an attachment arm extending downwardly from the perimeter lip.

11. The method of claim 10 further comprising the step of heating the attachment arm above the heat distortion temperature and then allowing the attachment arm to cool, thereby setting the attachment arm in the downward extending position.

12. The method of claim 10 wherein the condiment cup is thermoformed to include at least one grip enhancer extending outwardly from the upwardly extending sidewall adjacent the attachment arm, the at least one grip enhancer providing an outwardly extending sidewall that is integral with the upwardly extending sidewall and supports a grip surface, the grip surface being an elongate surface that is vertically aligned with and horizontally spaced from the attachment arm, a top edge of the grip surface being located further from the base than the terminal end of the attachment arm such that the grip surface is adapted to cooperate with the attachment arm to clamp the storage container sidewall and thereby support the condiment cup on the storage container sidewall.

13. The method of claim 10 wherein the means for resisting oxygen permeation is a sheet of EVOH, and wherein the thermoplastic material is integrated with the sheet of EVOH using a method comprises the steps of:
providing, in a stack, a first sheet of thermoplastic material, a first sheet of plastic adhesive, a first sheet of EVOH adhesive, the sheet of EVOH, a second sheet of EVOH adhesive, a second sheet of plastic adhesive, and then a second sheet of thermoplastic material; and
compressing the stack using a pair of rollers to form a composite sheet.

14. The method of claim 13 wherein the first and second sheets of thermoplastic material include either polyethylene or polypropylene.

15. The method of claim 10 wherein the means for resisting oxygen permeation is an oxygen resistant additive that is added to the thermoplastic material.

16. The method of claim 10 further comprising the step of trimming the condiment cup in a diecutting trim press to separate the condiment cup from an excess perimeter.

17. The method of claim 10 further comprising the steps of:
depositing a condiment into the storage space of the condiment cup;
providing a sealing lid having a lid perimeter;
positioning the sealing lid on top of the perimeter lip such that the lid perimeter abuts the perimeter lip; and
sealing the lid perimeter to the perimeter lip, thereby sealing closed the opening of the condiment cup.

18. A method of manufacturing a condiment cup, the method comprising the steps of:
providing a thermoplastic material having a means for resisting oxygen permeation;
thermoforming the thermoplastic material into the condiment cup, the condiment cup having a base and an upwardly extending sidewall that together define a storage space, the upwardly extending sidewall terminating in a perimeter lip that defines an opening for accessing the storage space, the terminal lip having an attachment arm that is generally conical in shape and extends downwardly from the perimeter lip outside of the storage space.

19. The method of claim 18 further comprising the step of trimming the condiment cup in a diecutting trim press to separate the condiment cup from an excess perimeter.

20. The method of claim 18 further comprising the steps of:
depositing a condiment into the storage space of the condiment cup;
providing a sealing lid having a lid perimeter;
positioning the sealing lid on top of the perimeter lip such that the lid perimeter abuts the perimeter lip; and
sealing the lid perimeter to the perimeter lip, thereby sealing closed the opening of the condiment cup.
